(19) United States
(12) Patent Application Publication
(10) Pub. No.: US 2017/0147985 A1
(43) Pub. Date: May 25, 2017

(54) PREDICTING AN OUTCOME OF THE EXECUTION OF A SCHEDULE

(71) Applicant: International Business Machines Corporation, Armonk, NY (US)

(72) Inventors: Kameshwaran Sampath, Bangalore (IN); Fabio Tiozzo, Vincennes (FR)

(21) Appl. No.: 14/952,661

(22) Filed: Nov. 25, 2015

(51) Int. Cl. G06Q 10/10; G06N 99/00

(52) U.S. Cl. CPC G06Q 10/1093; G06N 99/005

(57) ABSTRACT

A computer implemented method, computer program product and system for predicting an outcome of the execution of a schedule. The schedule, endogenous data relating to one or more activities or the schedule, and exogenous data relating to one or more activities or the schedule is processed in accordance with a machine learning algorithm-generated prediction model to predict at least one of: a performance measure, and a final condition that may result from executing the one or more activities according to the schedule.

### TECHNICAL FIELD

The present invention relates to the field of planning and scheduling, and more particularly, to predicting an outcome of executing activities according to a schedule.

### BACKGROUND

The planning and scheduling of a project or activities can influence the success, profitability or outcome of the project/activities. An accurate schedule can aid the decision making process and allocation of resources, and may help to ensure that the project/activities is/are executed in a manner consistent with the targets or planned outcome(s).

Due to various factors, which may or may not be easy to predict, it is typical for the actual outcome(s) from executing activities according to a planned schedule to not equal the planned/desired outcome(s). For example, miscalculations in activities and/or resources may result in delays, losses, etc. Also, after execution of the activities has commenced, various factors (internal and/or external to the system implementing the activities) may affect the activities and/or resources, and may therefore result in delays and/or or missed targets. In an attempt to account for this, it is known to monitor the execution of the schedule and take decisions or actions to minimize the impact of various factors. Furthermore, the schedule may be updated, altered or recalculated during the execution lifetime, so as to cater for changes.

However, it remains difficult to identify if and/or when a previously defined schedule should be altered or recalculated. The same is true for any decision/action (different from modifying/recreating the schedule) that aims to avoid the predicted outcomes or minimize the negative impacts on the outcomes. Adding more resources is an example of such decisions.

Since altering or changing a schedule can be very costly, inefficient and/or complicated, it may be preferable to avoid altering or changing a schedule whenever possible. Nonetheless, not altering or changing a schedule may have the disadvantage of resulting in delays and/or missed targets by failing to account for various factors impacting the scheduled activities.

Accordingly, a scheduling problem faced is identifying when it may be appropriate to alter or recalculate a previously defined schedule, so as to try to meet a desired target, performance or outcome. Alternatively, and/or additionally, it may be difficult to determine if a proposed (e.g. target) schedule end time/date should be modified, and furthermore making such a determination in due time may also be problematic.

### BRIEF SUMMARY

In one embodiment of the present invention, a computer implemented method for predicting an outcome of executing one or more activities according to a predetermined schedule comprises processing: the schedule; endogenous data relating to one or more activities or the schedule; and exogenous data relating to one or more activities or the schedule, in accordance with a machine learning algorithm-generated prediction model to predict at least one of: a performance measure, and a final condition that results from executing the one or more activities according to the schedule.

Other forms of the embodiment of the method described above are in a system and in a computer program product.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE DRAWINGS

A better understanding of the present invention can be obtained when the following detailed description is considered in conjunction with the following drawings, in which:

FIG. 1 depicts a pictorial representation of an example distributed prediction system in which aspects of the illustrative embodiments may be implemented;

FIG. 2 is a block diagram of an example prediction system in which aspects of the illustrative embodiments may be implemented;

FIG. 3 is a schematic block diagram of a system for predicting an outcome of executing one or more activities according to a predetermined schedule according to an embodiment;

FIG. 4 is a flow diagram of an exemplary implementation of a computer implemented method according to an embodiment;

FIG. 5 is simplified timeline illustrating an embodiment of predicting an outcome of executing a schedule whilst the schedule is executing; and

FIG. 6 illustrates an example of a computer within which one or more parts of an embodiment may be employed.

### DETAILED DESCRIPTION

It should be understood that the Figures are merely schematic and are not drawn to scale. It should also be understood that the same reference numerals are used throughout the Figures to indicate the same or similar parts.

Proposed is a concept of predicting an outcome of executing a predetermined schedule using a prediction model that has been generated by a machine learning algorithm. By processing the schedule, endogenous data and exogenous data in accordance with such a prediction model, an outcome (such as a performance measure or a final condition) of the executed schedule may be predicted, thereby enabling determination or assessment as to whether or not the executed schedule may meet a predetermined target, performance or outcome. Based on such information, a user may, for instance, decide if the schedule should be altered or, modified, or if other actions may be required. Thus, rather than determining exactly how a schedule should be altered, embodiments may instead provide information that may be useful for determining if a schedule should be altered. Nonetheless, predictions generated by proposed embodiments may also be useful (e.g., comprise information regarding predicted performance or final conditions) for determining how a schedule may be altered in order to meet a predetermined target, performance or outcome, for example.

Embodiments may employ the combined use of endogenous data and exogenous data to predict an outcome of executing a schedule. Endogenous and exogenous data may be related to anything that can affect the schedule (e.g. resource availability/resource efficiency) and not only the activities. Reference in general to ‘resources’ may include any type of resource and not only machinery or workers. Thus, components/materials, working space, all may be resources. A resource may be anything that is needed to execute a schedule and that may be needed to take into account for planning/scheduling. This may be thought of a making use of (i) internal information relating to internal aspects of the system or resources used to execute the schedule; and (ii) external information relating to external factors that are not part of the system or resources used to execute the schedule but which may still affect the system or resources used to execute the schedule. Examples of endogenous data may, for instance, relate to: the reliability of machinery used to execute an activity of the schedule; the availability of resources used by an activity of the schedule; planned maintenance of equipment (such a machines, tools, etc.); and performance degradation rates. Examples of exogenous data may, for instance, relate to: the weather; recent, current or near future events; predictors of staff attendance; scheduled holidays or events; and power disruptions.

Reference to an ‘endogenous variable’ may thus be taken to refer to a dependent variable generated within a model (e.g., system for executing a schedule) and, therefore, a variable whose value is changed (determined) by one of the functional relationships in that model. Conversely, reference to an ‘exogenous variable’ may be taken to refer to an independent variable that affects a model (e.g., system for executing a schedule) without being affected by it, and whose qualitative characteristics and method of generation are not specified by the model builder. Thus, an exogenous variable is used for setting arbitrary external conditions.

A classification of a variable may therefore be explained by the relationships between functions within the model/system. For example, the equilibrium price of a product/item in a supply and demand model is endogenous because it is set by a producer in response to consumer demand. It is the opposite of an exogenous variable.

Endogenous data may therefore be understood to relate to one or more endogenous variables or parameters of the one or more activities or the schedule that can be altered by a relationship between the one or more activities and/or the schedule. Conversely, exogenous data may be understood to relate to one or more exogenous variables or parameters that can affect the one or more activities and/or the schedule without being affected by the one or more activities and/or the schedule. Both endogenous and exogenous data may therefore relate to ‘stochastic’ variables. For example, exogenous data may include information relating to a weather forecast that may state, for example: tomorrow with an accuracy of 80% the temperature will be less than −20 degrees, with accuracy 10% between −20 degrees and −15 degrees, and with accuracy 10% greater than −15 degrees. On the other hand, exogenous data may include information descriptive of the fact that we definitively know that the current temperature is −5 degrees (e.g., with an accuracy of 100%). A further example may be that the probability that a truck drivers' strike will hit tomorrow our material deliveries may be 70%. Similarly, endogenous data may include information relating to a machine failure prediction which may state, for example, machine A is failing in x days: in 1 day with accuracy 70%; in 2 days with accuracy 10%; in 3 days with accuracy 5%; and in more than 3 days with accuracy 15%. Thus, in general, for each of these variables, the input information may comprise a (continuous or discrete) distribution of probability of the possible values the variable can assume.

Furthermore, endogenous data used by an embodiment may comprise historical data relating to one or more previously obtained values for a variable or parameter. These previously obtained values may, for example, be resultant from executing one or more activities according to the schedule or a similar schedule. Thus, embodiments may make use of historical data, such as the actual obtained outcomes or performance from previously performing the same schedule in the same or similar circumstances, or actual obtained outcomes or performance from previously performing a similar schedule in the same or similar circumstances. Embodiments may therefore make use of historical data to improve the accuracy of predictions.

It may be proposed to automatically predict an outcome of a schedule based on a prediction model that has been learnt from the execution of past schedules (e.g., historical information). Embodiments may therefore employ a prediction model that has been generated by a machine learning algorithm. Preferred machine learning models may, for example, be trained using historical data, with possible assistance in labeling from human experts.

Machine learning is a sub-field of computer science that evolved from the study of pattern recognition and computational learning theory in artificial intelligence. Machine learning explores the study and construction of algorithms that can learn from and make predictions on data. Machine learning algorithms operate by building a model from example inputs in order to make data-driven predictions or decisions, rather than following strictly static program instructions.

Many different approaches or algorithms exist and are well-known. For example, machine learning approaches include: decision tree learning; association rule learning; artificial neural networks; inductive logic programming; support vector machines; clustering; Bayesian networks; reinforcement learning; representation learning; similarity and metric learning; sparse dictionary learning; and genetic algorithms. It will be understood that any such machine learning approach or algorithm may be applicable to proposed embodiments. Also, embodiments may employ machine learning approaches or algorithms that are yet to be developed.

Proposed embodiments may make use of event data when making a prediction. Such event data may, for example, relate to an occurrence of an event (e.g., extreme weather event, or worker strike) that may alter the endogenous data or exogenous data relating to the one or more activities. In this way, predictions may be made more accurate by accounting for events that may be otherwise difficult to predict and/or plan for. Worst-case scenario predictions may therefore be catered for, for instance.

For instance, one or more machine learning algorithms employed to generate the prediction model may be trained with one or more previously obtained performance measures or final conditions and their deviation respect to the planned ones. Such previously obtained performance measures or final conditions may have been obtained from executing the schedule or from executing a differing schedule with the same or similar endogenous data, exogenous data, and/or event data.

Embodiments may therefore employ the following types of data in the training part of the machine learning process;

(i) a history of past schedules saved before their release to execution and during the execution (the remaining to be executed schedule will be saved in this latter case);

(ii) a history of past deviations of actual/obtained value(s) from planned value(s);

(iii) the value(s) of endogenous and exogenous variables at the beginning of a scheduling period (certain variables could represent random variables in the future, e.g., predicted machine failures, weather forecast, etc.);

(iv) current and planned status of the resources;

(v) how the execution of the schedule has performed up until a particular moment in time.

The examples of data provided above may not be independent ‘histories.’ For example, an approach to use such data may be to make “snapshots” of the data at different points in time during the execution of a schedule and save the data to be used by learning algorithms so as to build the predictive models.

If one imagines normally building a schedule at the beginning of the week for the entire week, it could be decided to take a snapshot of all the data at the beginning of each day. Thus, for seven-day schedules, eight (8) snapshots may be saved (7+1 at the end). The first snapshot may then represent a schedule of seven (7) days, the second snapshot may represent a schedule of six (6) days, and so forth with the seventh snapshot representing a schedule of a single day. The last represents the end of the schedule when the actual outcomes may be measured.

For each of these snapshots, information stored may be as follows:

For the planned outcomes: The re-adjusted planned performance or final conditions. This value that has to take into account the execution of the schedule so far: e.g., initially planned outcome 100 pieces, already done 10, then new adjusted planned outcome=90.

For the actual outcomes: The contribution to the outcomes of that partial schedule.

In this way, the past history of not only of the complete seven days schedule may be stored, but also the history of all the partial schedules. Thus, predictive models for schedules of length 1 day, 2 days, . . . , 7 days may be built, which may increase the predictive power of the models.

Starting from the sources of data, embodiments may extract, transform and build features or predictors using standard machine learning data preparation methodologies and tools. For example, any one or more of a suite of machine algorithms may be used, and depending on the training data and the nature of a prediction, the most suitable algorithm(s) may be selected, e.g., continuous or discrete predictions (using regression), identifying the schedule to one of the pre-defined categories (using classification); grouping the schedule to one of the categories (using cluster analysis); and/or identifying the relative position of the schedule (using ranking).

Illustrative embodiments may therefore provide concepts for processing: the schedule; endogenous data and exogenous data in accordance with a prediction model (generated using machine learning algorithm) in order to predict a performance measure or final condition that may result from executing activities according to the schedule.

Put another way, there is proposed a concept of predicting an outcome of an executed schedule by using a prediction model that has been generated using a machine learning algorithm. The machine learning algorithm may employ schedule data along with endogenous and exogenous data. Thus, proposed concepts may employ endogenous and exogenous data which enables the prediction of an outcome prior to (or during) the scheduled activities being executed. Such an approach may enable a schedule or plan to be assessed against a desired or target outcome, thereby assisting in identification of a potential need to alter or update the schedule/plan (or take other action(s)).

Embodiments may therefore be thought of as using a combination of endogenous and exogenous data with machine learning to provide an outcome prediction ability that may be used to determine the suitability of a schedule of activities.

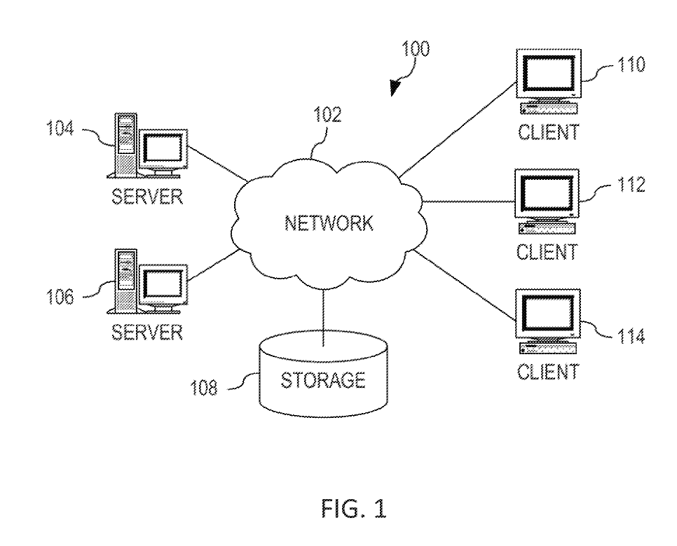

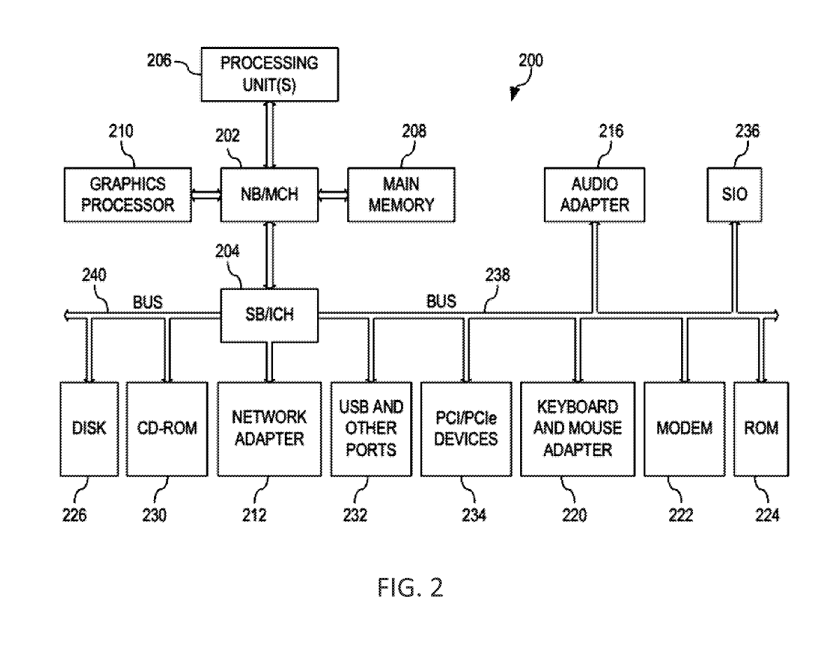

Illustrative embodiments may be utilized in many different types of data processing environments. In order to provide a context for the description of elements and functionality of the illustrative embodiments, FIGS. 1 and 2 are provided hereafter as example environments in which aspects of the illustrative embodiments may be implemented. It should be appreciated that FIGS. 1 and 2 are only examples and are not intended to assert or imply any limitation with regard to the environments in which aspects or embodiments of the present invention may be implemented. Many modifications to the depicted environments may be made without departing from the spirit and scope of the present invention.

FIG. 1 depicts a pictorial representation of an example distributed prediction system in which aspects of the illustrative embodiments may be implemented. Distributed prediction system 100 may include a network of computers in which aspects of the illustrative embodiments may be implemented. The distributed prediction system 100 contains at least one network 102, which is the medium used to provide communication links between various devices and computers connected together within distributed data processing system 100. The network 102 may include connections, such as wire, wireless communication links, or fiber optic cables.

In the depicted example, a first 104 and second 106 servers are connected to the network 102 along with a storage unit 108. In addition, clients 110, 112, and 114 are also connected to the network 102. The clients 110, 112, and 114 may be, for example, personal computers, network computers, or the like. In the depicted example, the first server 104 provides data, such as boot files, operating system images, and applications to the clients 110, 112, and 114. Clients 110, 112, and 114 are clients to the first server 104 in the depicted example. The distributed prediction system 100 may include additional servers, clients, and other devices not shown.

In the depicted example, the distributed prediction system 100 is the Internet with the network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

FIG. 2 is a block diagram of an example prediction system 200 in which aspects of the illustrative embodiments may be implemented. The prediction system 200 is an example of a computer, such as client 110 in FIG. 1, in which computer usable code or instructions implementing the processes for illustrative embodiments of the present invention may be located.

In the depicted example, the prediction system 200 employs a hub architecture including a north bridge and memory controller hub (NB/MCH) 202 and a south bridge and input/output (I/O) controller hub (SB/ICH) 204. A processing unit 206, a main memory 208, and a graphics processor 210 are connected to NB/MCH 202. The graphics processor 210 may be connected to the NB/MCH 202 through an accelerated graphics port (AGP).

In the depicted example, a local area network (LAN) adapter 212 connects to SB/ICH 204. An audio adapter 216, a keyboard and a mouse adapter 220, a modem 222, a read only memory (ROM) 224, a hard disk drive (HDD) 226, a CD-ROM drive 230, a universal serial bus (USB) ports and other communication ports 232, and PCI/PCIe devices 234 connect to the SB/ICH 204 through first bus 238 and second bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

The HDD 226 and CD-ROM drive 230 connect to the SB/ICH 204 through second bus 240. The HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on the processing unit 206. The operating system coordinates and provides control of various components within the prediction system 200 in FIG. 2. As a client, the operating system may be a commercially available operating system. An object-oriented programming system, such as the Java™ programming system, may run in conjunction with the operating system and provides calls to the operating system from Java™ programs or applications executing on prediction system 200.

As a server, prediction system 200 may be, for example, an IBM® eServer™ System p® computer system, running the Advanced Interactive Executive (AIX®) operating system or the LINUX® operating system. The prediction system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. Similarly, one or data structures according to an embodiment may be adapted to be stored by the storage devices and/or the main memory 208.

The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as first bus 238 or second bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as the modem 222 or the network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the system mentioned previously, without departing from the spirit and scope of the present invention.

Moreover, the prediction system 200 may take the form of any of a number of different data processing systems including client computing devices, server computing devices, a tablet computer, laptop computer, telephone or other communication device, a personal digital assistant (PDA), or the like. In some illustrative examples, the prediction system 200 may be a portable computing device that is configured with flash memory to provide non-volatile memory for storing operating system files and/or user-generated data, for example. Thus, the prediction system 200 may essentially be any known or later-developed data processing system without architectural limitation.

A proposed concept may enhance a planning or scheduling system/method by enabling an outcome of the schedule to be predicted. Embodiments may enable the performance of final conditions of a schedule to be determined, thereby empowering a user with information that may be used to determine if a schedule should be altered in order to meet a target performance or condition (or any other action needs to be taken).

In particular, it is proposed to employ embodiments in dynamic (changing) environments with repeated or dynamic prediction using up-to-date data in order to facilitate reactive or adaptive learning about the schedule. For example, repeated prediction of a schedule outcome using the latest data available as the schedule actually executes, may enable continuous learning and adaptation of a schedule. Using data obtained during execution of a schedule, embodiments may employ the concept of training a machine learning algorithm as the schedule executes so as to improve the accuracy of prediction model. Embodiments may therefore work seamlessly in real-time environments (like order processing, for example) at high-speed and/or without human-intervention.

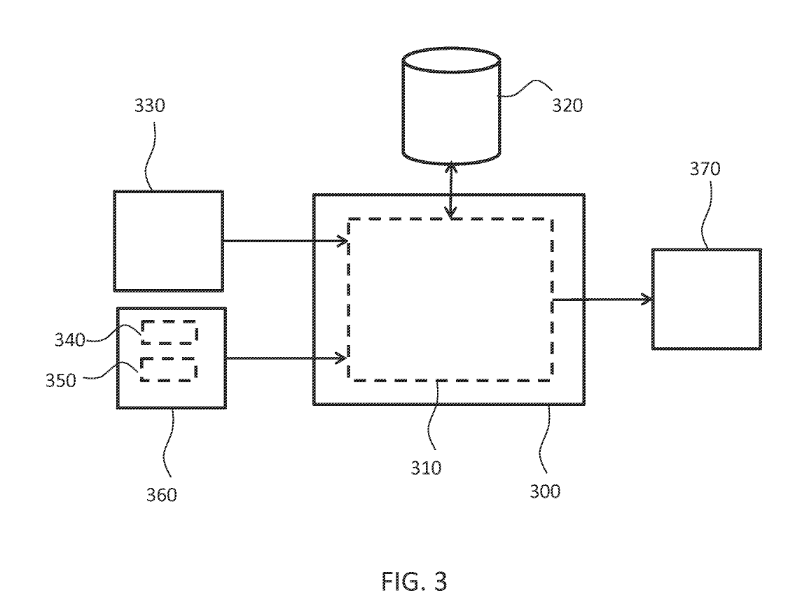

With reference to FIG. 3, a system 300 for predicting an outcome of executing one or more activities according to a predetermined schedule may comprise a processing unit 310 adapted to process data in accordance with a machine learning algorithm-generated prediction model.

In this example, the prediction model (which has been generated using a machine learning algorithm) is stored in a data store 320 that is accessible by the processing unit 310. In this way, the processing unit 320 may receive or retrieve information about a prediction model from the data store, and the processing unit 320 may also transmit or provide information (e.g., for modifying a prediction model and/or for defining a new prediction model) for storage in the data store.

Schedule data for representing a predetermined schedule may be provided to the processing unit 310 via a first input interface 330. By way of example, the first input interface 330 for providing a schedule to the processing unit 310 may comprise a scheduling application/program implemented on a computer system that has a graphical user interface which is adapted to receive user inputs for defining and/or altering a schedule of activities.

Endogenous 340 and exogenous 350 data relating to one or more activities or the predetermined schedule may be provided to the processing unit 310 via a second input interface 360. By way of example, the second input interface 360 for providing endogenous 340 and exogenous 350 data to the processing unit 310 may comprise a schedule supervision application/program implemented on an computer system that has a graphical user interface which is adapted to receive user inputs for defining and/or altering endogenous 340 and/or exogenous 350 data relating to activities or schedules.

Endogenous data 340 may relate to endogenous variables or parameters of activities or a schedule that can be altered by a relationship between the activities and/or the schedule. For example, endogenous data may relate to a dependent variable generated within a system that executes a schedule and, therefore, a variable whose value is changed (determined) by a functional relationship in the system. Examples of such endogenous data may, for instance, be representative of: a reliability of machinery used to execute an activity of the schedule; an availability of resources used by an activity of the schedule; planned maintenance of the machinery or resources used in the system; or a performance degradation rate. Such endogenous data 340 may therefore be user-defined (e.g., provided by a person with knowledge or experience of the system or schedule) and/or it may be automatically detected and provided by a sensing arrangement that is adapted to monitor components or relationships in the system.

Endogenous data 340 may also be based on and/or include historical data relating previously obtained values for a variable or parameter. Use of historical data may provide for accurate representation of variables or factors within a system implementing a schedule because the historical data may provide information derived from real/actual implementations of a schedule (which may otherwise be difficult or impossible to evaluate or approximate). For example, the one or more previously obtained values may have resulted from executing activities according to the schedule or a similar schedule. Information may therefore be obtained from an already executed schedule, thus providing potential valuable insight into actual executing outcomes.

Exogenous data 350 may relate to exogenous variables or parameters that can affect activities and/or a schedule without being affected by the activities and/or the schedule. For example, exogenous data 350 may relate to an independent variable that affects a system for executing a schedule without being affected by it. Qualitative characteristics and/or methods of generation of exogenous data or variable may therefore be entirely independent from a system for executing a schedule. Thus, exogenous data 350 may be used for representing arbitrary external conditions.

Examples of exogenous data may, for instance, be representative of: the weather; recent, current or near future events; predictors of staff attendance; scheduled holidays or events; and power disruptions. Such exogenous data 350 may therefore be user-defined (e.g., provided by a person with knowledge or experience of external factors and how they may impact activities and/or system) and/or it may be automatically detected and provided by a sensing arrangement that is adapted to monitor external factor/conditions.

In this embodiment, schedule data is provided to the processing unit 310 via a first input interface 330, and endogenous data 340 and exogenous data 350 are loaded to the processing unit 310 of the system 300. A machine learning algorithm-generated prediction model is then provided from the data store 320 to the processing unit 310. The processing unit 310 processes: the schedule data; endogenous data 340; and exogenous data 350 in accordance with the prediction model to predict an outcome of executing the schedule. Here, the outcome may be a performance measure and/or a final condition that may result from executing activities according to the schedule. By way of an example, an outcome may comprise any suitable value for describing a resulting condition, state, output or form of an activity or the system performing the activities according to the schedule. Thus, an outcome may be described using values representative of things, such as: number of output products/items; time of completion; quality of output(s); turnover; speed; quantity of a material or product; throughput; start/end temperature; or size, for example. A performance measure may therefore be representative of a deviation of an outcome from a target value, for example. Similarly, a final condition may be representative of one or more outcomes.

When performing the processing in order to determine an outcome, the processing unit 310 may also process event data in accordance with the prediction model. For example, event data may relate to an occurrence of an event that can alter the endogenous data or exogenous data, and such event data may be provided to the processing unit via by a user or external processing system. In this way, the system may be adapted to consider the potential effect of extreme events, sudden or unexpected changes in parameters or variables, and/or ‘what-if’ scenarios. By taking account of such event data, the processing unit 310 may predict an outcome for rare or exceptional circumstance, and such information may be useful for determining the suitability of a schedule for a wide range of circumstance and/or determining what may cause a schedule to fail (e.g., not meet predetermined performance or outcome requirements).

The processing unit 310 is adapted to provide its predictions to an output interface 370 for communication to a user or another system. For example, the output interface 370 may comprise a display unit adapted to display one or more graphical elements based on prediction information output from the processing unit 310. The displayed graphical element(s) may then be viewed by a user so that the user can then assess a predicted outcome of executing a schedule. Based on such an assessment, the user may decide whether or not the schedule needs to be modified (in order to meet a desired or target outcome, for example), and/or any other action may be needed to avoid or mitigate the impact of predicted outcomes: e.g., adding extra resources, getting more skilled workers.

Thus, it will be understood that, in the above-described example of FIG. 3, endogenous and/or exogenous data relating to one or more activities or a schedule may be processed in accordance with a machine learning-generated prediction model in order to predict an outcome that may result from executing the one or more activities according to the schedule. It may then be determined whether the schedule is appropriately defined in order to meet a predetermined demand, for example. In this way, inadequate or unrealistic schedules may be identified, thus providing for the opportunity to modify the schedule so that, for instance, it is able to meet the predetermined demand.

The example of FIG. 3 may also employ the predictions generated by the processing unit and/or previously obtained performance measures or final conditions to refine (e.g., train or update) the prediction model, and such training may employ a machine learning algorithm. In this way, a machine learning algorithm may be employed in conjunction with newly obtained and/or up-to-date information about the executing schedule so as to enable more accurate predictions to be obtained.

Some embodiments may enable as enabling ongoing and dynamic outcome prediction for a schedule even as the schedule executes. In this way, detected outcomes or values from performing part of a schedule may be used to predict an outcome of performing the remaining part of the same schedule. This may enable ongoing assessment of a schedule as it is being executed, thus potentially enabling determination of whether or not a currently executing schedule should be modified.

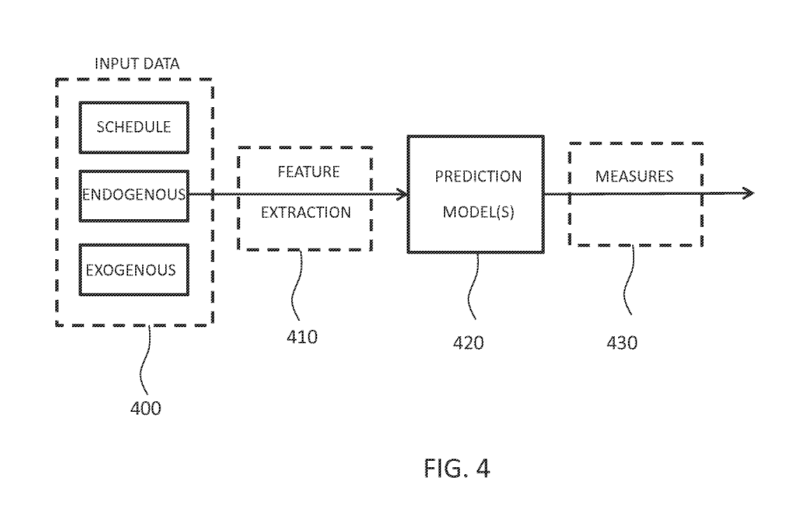

Turning now to FIG. 4, an exemplary implementation of a computer implemented method according to an embodiment will now be described.

The method begins in step 400 with input data being provided to a system according to an embodiment. Here, the data comprises: schedule data relating to a schedule of activities; endogenous data relating to the activities and/or the schedule; and exogenous data relating to the activities and/or the schedule. The system then processes the data in step 410 to extract features.

Here, step 410, comprises implementing an Extract, Transform, and Load (ETL) algorithm which calculates features (X₁, . . . , X_{N}) of the data for inputting into a prediction model.

Examples of features from a schedule may include: workload on resources; time slack between activities on resources; overlap duration between activities; and common resource usages between activities.

Examples of features from endogenous data may include: time since last maintenance on resources; next point of failure prediction; key performance indicators of resources (e.g., mean and variance or processing times and utilization rate in the recent past); and availability of raw materials, components and of any required resources.

Examples of features from exogenous data may include: current calendar period (seasonality); forecasts for order changes and demand uncertainties; public events (e.g., holidays, festivals, labor strikes); weather forecasts.

Here, it is noted that, without loss of generality, we can assume N features. In a training phase of a machine learning prediction model, one may choose which features are relevant for a performance measure.

Next, in step 420, one or more prediction models are used in conjunction with the extracted features to predict performance measures and/or final conditions that may result from executing the activities according to the schedule. The system then processes the predictions in step 430 to extract measures.

Here, observed or detected value/data obtained from actually executing the schedule may be compared with the predictions to calculate/generate performance measures. By way of example, the performance measure may representative of values such as: actual key performance indicators (KPIs) and their deviation; deviations of actual execution outcomes/conditions from targets; the number of times rescheduling was required, etc.

A measure for each extracted feature may be obtained. Thus, for example, in an embodiment where each Friday afternoon a user (e.g., a planner) prepares a weekly schedule for the next week, a schedule may be released to the production department early Monday morning. The schedule may be built with a target/goat to achieve certain levels of KPIs by the end of the week (e.g., weekly production of product P_{d}).

The features and associated measures for each week may be represented as a table like Table 1 below:

TABLE 1

| | Features | Measures |
|---|---|---|
| Week | (Monday 8 am) | (Friday 5 pm) |
| Week_1 | <X₁, . . . , X_{N}> | <M1, M2, B1, B2, N1> |
| Week_2 | <X₁, . . . , X_{N}> | <M1, M2, B1, B2, N1> |
| . . . | . . . | . . . |

Past observed data (e.g., from Week 1) may be used to train the prediction model(s) individually for each measure. Thus, by way of example, a prediction model for measure M1 may be trained using historical data for measure M1 and a linear regression-based machine learning algorithm. Similarly, a prediction model for measure M2 may be trained using historical data for measure M2 and a logistic regression-based machine learning algorithm. A prediction model for measure N1 may be trained using historical data for measure N1 and a decision tree-based machine learning algorithm.

Also, it will be appreciated that embodiments may be employed in dynamic (changing) environments wherein repeated or dynamic predictions may be generated using up-to-date data. This may facilitate reactive or adaptive learning about the schedule.

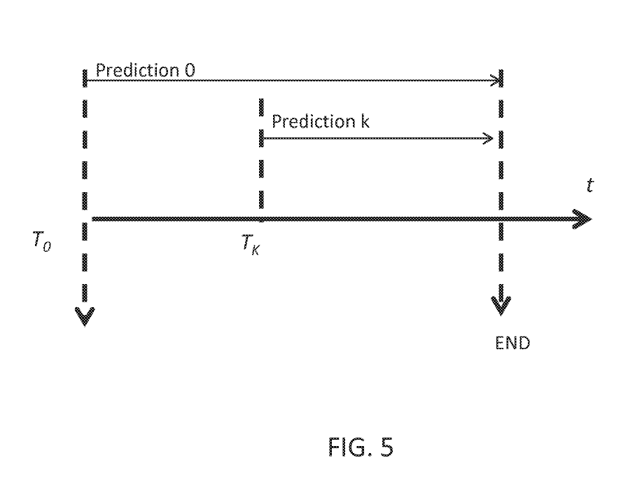

For example, with reference to FIG. 5, a first prediction (“Prediction 0”) for a schedule may be obtained at time T₀ at or before the time the schedule begins execution. After time has elapsed during execution of the schedule, a second, updated prediction (“Prediction k”) may be obtained at time T_{K} (i.e., after a K amount of time T_{K} has elapsed). The second updated prediction (Prediction k) may be based on data (e.g., endogenous and/or exogenous data) obtained during execution of a schedule (e.g., during the time period from T₀ to T_{K}). This may help to improve the accuracy of predictions and/or the prediction model(s). Also, such embodiments may work seamlessly and dynamically in real-time environments (like order processing, for example) so as to provide updated outcomes predictions whilst a schedule is executing.

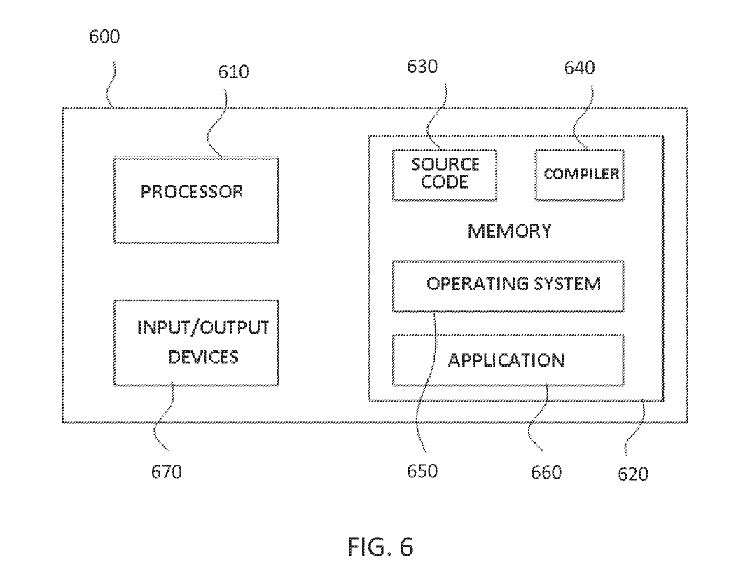

FIG. 6 illustrates an example of a computer 600 within which one or more parts of an embodiment may be employed. Various operations discussed above may utilize the capabilities of the computer 600. For example, one or more parts of a system for converting synchronous operations into asynchronous operations may be incorporated in any element, module, application, and/or component discussed herein.

The computer 600 includes, but is not limited to, PCs, workstations, laptops, PDAs, palm devices, servers, storages, and the like. Generally, in terms of hardware architecture, the computer 600 may include one or more processors 610, memory 620, and one or more I/O devices 670 that are communicatively coupled via a local interface (not shown). The local interface can be, for example but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the aforementioned components.

The processor 610 is a hardware device for executing software that can be stored in the memory 620. The processor 610 can be virtually any custom made or commercially available processor, a central processing unit (CPU), a digital signal processor (DSP), or an auxiliary processor among several processors associated with the computer 600, and the processor 610 may be a semiconductor based microprocessor (in the form of a microchip) or a microprocessor.

The memory 620 can include any one or combination of volatile memory elements (e.g., random access memory (RAM), such as dynamic random access memory (DRAM), static random access memory (SRAM), etc.) and non-volatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 620 may incorporate electronic, magnetic, optical, and/or other types of storage media. Note that the memory 620 can have a distributed architecture, where various components are situated remote from one another, but can be accessed by the processor 610.

The software in the memory 620 may include one or more separate programs, each of which comprises an ordered listing of executable instructions for implementing logical functions. The software in the memory 620 includes a suitable operating system (O/S) 650, compiler 640, source code 630, and one or more applications 660 in accordance with exemplary embodiments. As illustrated, the application 660 comprises numerous functional components for implementing the features and operations of the exemplary embodiments. The application 660 of the computer 600 may represent various applications, computational units, logic, functional units, processes, operations, virtual entities, and/or modules in accordance with exemplary embodiments, but the application 660 is not meant to be a limitation.

The operating system 650 controls the execution of other computer programs, and provides scheduling, input-output control, file and data management, memory management, and communication control and related services. It is contemplated by the inventors that the application 660 for implementing exemplary embodiments may be applicable on all commercially available operating systems.

Application 660 may be a source program, executable program (object code), script, or any other entity comprising a set of instructions to be performed. When a source program, then the program is usually translated via a compiler (such as the compiler 640), assembler, interpreter, or the like, which may or may not be included within the memory 620, so as to operate properly in connection with the O/S 650. The I/O devices 670 may include input devices such as, for example but not limited to, a mouse, keyboard, scanner, microphone, camera, etc. Furthermore, the I/O devices 670 may also include output devices, for example but not limited to a printer, display, etc. Finally, the I/O devices 670 may further include devices that communicate both inputs and outputs, for instance but not limited to, a NIC or modulator/demodulator (for accessing remote devices, other files, devices, systems, or a network), a radio frequency (RF) or other transceiver, a telephonic interface, a bridge, a router, etc. The I/O devices 670 also include components for communicating over various networks, such as the Internet or intranet.

If the computer 600 is a PC, workstation, intelligent device or the like, the software in the memory 620 may further include a basic input output system (BIOS) (omitted for simplicity). The BIOS is a set of essential software routines that initialize and test hardware at startup, start the O/S 650, and support the transfer of data among the hardware devices. The BIOS is stored in some type of read-only-memory, such as ROM, PROM, EPROM, EEPROM or the like, so that the BIOS can be executed when the computer 600 is activated.

When the computer 600 is in operation, the processor 610 is configured to execute software stored within the memory 620, to communicate data to and from the memory 620, and to generally control operations of the computer 600 pursuant to the software. The application 660 and the O/S 650 are read, in whole or in part, by the processor 610, perhaps buffered within the processor 610, and then executed.

When the application 660 is implemented in software it should be noted that the application 660 can be stored on virtually any computer readable medium for use by or in connection with any computer related system or method. In the context of this document, a computer readable medium may be an electronic, magnetic, optical, or other physical device or means that can contain or store a computer program for use by or in connection with a computer related system or method.

The application 660 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium.

In the context of the present application, where embodiments of the present invention constitute a method, it should be understood that such a method is a process for execution by a computer, i.e., is a computer implementable method. The various steps of the method therefore reflect various parts of a computer program, e.g., various parts of one or more algorithms.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a storage class memory (SCM), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions tier carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for predicting an outcome of executing a predetermined schedule, the method comprising:
receiving schedule data relating to a schedule of activities;
receiving endogenous data relating to one or more of said activities and said schedule, wherein said endogenous data relates to one or more endogenous variables or parameters of one or more of said activities and said schedule that can be altered by a relationship between one or more of said activities and said schedule whereby said endogenous data are percentage predictions, wherein said endogenous data comprises data related to reliability of machinery used to execute an activity of said schedule, availability of resources used by an activity of said schedule, planned maintenance of equipment and performance degradation rates;
receiving exogenous data relating to one or more of said activities and said schedule, wherein said exogenous data relates to one or more exogenous variables or parameters that can affect one or more of said activities and said schedule without being affected by one or more of said activities and said schedule whereby said exogenous data are descriptive of facts;
processing said schedule data, said endogenous data and said exogenous data to extract features;
utilizing, by a processor, a prediction model generated using a machine learning algorithm in conjunction with said extracted features to predict performance measures resulting from executing activities according to said schedule, wherein said performance measures are used by a user to determine if said schedule needs to be altered to meet a target performance;
detecting at least one of a performance measure, and a final condition resultant from executing one or more activities according to said schedule;
determining a deviation between: the detected performance measure and/or final condition, and a planned or predicted performance measure and/or final condition; and
generating a revised prediction model based on the determined deviation.

2. (canceled)

3. The method of claim 1, wherein the endogenous data comprises historical data relating to one or more previously obtained values for a variable or parameter of the one or more activities or the schedule.

4. The method of claim 3, wherein the one or more previously obtained values are resultant from executing one or more activities according to the schedule or a similar schedule.

5. The method of claim 1, wherein said features comprise workload on resources, time slack between activities on resources, overlap duration between activities and common resource usages between activities.

6. The method of claim 1, further comprising:
training the machine learning algorithm with one or more previously obtained performance measures or final condition.

7. The method of claim 6, wherein the one or more previously obtained performance measures or final conditions are resultant from executing one or more activities according to at least one of: the schedule, and a differing schedule with the same or similar endogenous data, exogenous data, and/or event data.

8. (canceled)

9. The method of claim 1, wherein said exogenous data is user-defined and automatically detected and provided by a sensing arrangement that is adapted to monitor external conditions.

10. A computer program product for predicting an outcome of executing one or more activities according to a predetermined schedule, the computer program product comprising a computer readable storage medium having program code embodied therewith, the program code comprising the programming instructions for:
receiving schedule data relating to a schedule of activities;
receiving endogenous data relating to one or more of said activities and said schedule, wherein said endogenous data relates to one or more endogenous variables or parameters of one or more of said activities and said schedule that can be altered by a relationship between one or more of said activities and said schedule whereby said endogenous data are percentage predictions, wherein said endogenous data comprises data related to reliability of machinery used to execute an activity of said schedule, availability of resources used by an activity of said schedule, planned maintenance of equipment and performance degradation rates;
receiving exogenous data relating to one or more of said activities and said schedule, wherein said exogenous data relates to one or more exogenous variables or parameters that can affect one or more of said activities and said schedule without being affected by one or more of said activities and said schedule whereby said exogenous data are descriptive of facts;
processing said schedule data, said endogenous data and said exogenous data to extract features;
utilizing a prediction model generated using a machine learning algorithm in conjunction with said extracted features to predict performance measures resulting from executing activities according to said schedule, wherein said performance measures are used by a user to determine if said schedule needs to be altered to meet a target performance;
detecting at least one of a performance measure, and a final condition resultant from executing one or more activities according to said schedule;
determining a deviation between: the detected performance measure and/or final condition, and a planned or predicted performance measure and/or final condition; and
generating a revised prediction model based on the determined deviation.

11-20. (canceled)

21. The computer program product of claim 10, wherein the endogenous data comprises historical data relating to one or more previously obtained values for a variable or parameter of the one or more activities or the schedule.

22. The computer program product of claim 21, wherein the one or more previously obtained values are resultant from executing one or more activities according to the schedule or a similar schedule.

23. The computer program product of claim 10, wherein said features comprise workload on resources, time slack between activities on resources, overlap duration between activities and common resource usages between activities.

24. The computer program product of claim 10, wherein the program code further comprises the programming instructions for:
training the machine learning algorithm with one or more previously obtained performance measures or final conditions.

25. The computer program product of claim 24, wherein the one or more previously obtained performance measures or final conditions are resultant from executing one or more activities according to at least one of: the schedule, and a differing schedule with the same or similar endogenous data, exogenous data, and/or event data.

26. (canceled)

27. The computer program product of claim 10, wherein said exogenous data is user-defined and automatically detected and provided by a sensing arrangement that is adapted to monitor external conditions.

28. A system, comprising:
a memory unit for storing a computer program for predicting an outcome of executing one or more activities according to a predetermined schedule; and
a processor coupled to the memory unit, wherein the processor is configured to execute the program instructions of the computer program comprising:
receiving schedule data relating to a schedule of activities;
receiving endogenous data relating to one or more of said activities and said schedule, wherein said endogenous data relates to one or more endogenous variables or parameters of one or more of said activities and said schedule that can be altered by a relationship between one or more of said activities and said schedule whereby said endogenous data are percentage predictions, wherein said endogenous data comprises data related to reliability of machinery used to execute an activity of said schedule, availability of resources used by an activity of said schedule, planned maintenance of equipment and performance degradation rates;
receiving exogenous data relating to one or more of said activities and said schedule, wherein said exogenous data relates to one or more exogenous variables or parameters that can affect one or more of said activities and said schedule without being affected by one or more of said activities and said schedule whereby said exogenous data are descriptive of facts;
processing said schedule data, said endogenous data and said exogenous data to extract features;
utilizing a prediction model generated using a machine learning algorithm in conjunction with said extracted features to predict performance measures resulting from executing activities according to said schedule, wherein said performance measures are used by a user to determine if said schedule needs to be altered to meet a target performance;
detecting at least one of a performance measure, and a final condition resultant from executing one or more activities according to said schedule;
determining a deviation between: the detected performance measure and/or final condition, and a planned or predicted performance measure and/or final condition; and
generating a revised prediction model based on the determined deviation.

29. The system of claim 28, wherein said features comprise workload on resources, time slack between activities on resources, overlap duration between activities and common resource usages between activities.

30. (canceled)

31. The system of claim 28, wherein said exogenous data is user-defined and automatically detected and provided by a sensing arrangement that is adapted to monitor external conditions.
